(19) United States
(12) Patent Application Publication
(10) Pub. No.: US 2014/0157279 A1
(43) Pub. Date: Jun. 5, 2014

(54) INFORMATION PROCESSING APPARATUS, INFORMATION PROCESSING SYSTEM, INFORMATION PROCESSING METHOD AND CONTROL PROGRAM STORAGE MEDIUM

(71) Applicant: NEC CORPORATION, Tokyo (JP)

(72) Inventor: Takashi Horikawa, Tokyo (JP)

(73) Assignee: NEC CORPORATION, Tokyo (JP)

(21) Appl. No.: 14/233,086

(22) PCT Filed: Jul. 18, 2012
(86) PCT No.: PCT/JP2012/068748

§ 371 Date: Jan. 15, 2014

(30) Foreign Application Priority Data
Jul. 29, 2011 (JP) 2011-167691

(51) Int. Cl. G06F 9/52

(52) U.S. Cl. CPC G06F 9/52
USPC 718/102

(57) ABSTRACT

Provided is an information processing apparatus. The information processing apparatus includes thread control means for, at starting a plurality of threads, giving an identifier to the thread, and, at ending the each thread, notifying of an end along with the identifier; and data element control means for, in case that a deletion thread which deletes a data element from list-structured data being executed, maintaining a content of the deleted data element in an unmodifiable state until ends of all the threads which started before the deletion processing by the deletion thread being confirmed by a notification of the end along with the identifier, and, in case that the ends of all the threads which started before the deletion processing by the deletion thread being notified of along with the identifier, putting the deleted data element into a reusable state.

### TECHNICAL FIELD

The present invention relates to an information processing technology for deleting a data element from data structured as a list in an information processing system which executes a plurality of threads in a parallel way.

### BACKGROUND ART

For example, in the above technical field, a “cmpxchg” instruction is known as a method for executing accesses from a plurality of threads without any discrepancy while avoiding making a critical section. The “cmpxchg” instruction is disclosed in “Intel 64 and IA-32 Architectures Software Developer's Manual Volume 2A: Instruction Set Reference, A-M” (hereinafter, it is referred to as non-patent document 1). By a CAS (Compare And Swap) operation, the “cmpxchg” instruction which is a typical example of a multiprocessor instruction is controlled so that a memory may not be changed by other instructions during execution of the instruction.

In “Maged M. Michael, High Performance Dynamic Lock-Free Hash Tables and List-Based Sets, ACM SPAA'02” (hereinafter, referred to as non-patent document 2), there is disclosed an algorithm from which a correct execution result is obtained using the above-mentioned CAS operation when inserting a data element into a data structured as a list or deleting the data element from the data structured as the list. Here, a list structure is a structure in which a plurality of data elements are connected by a pointer. In non-patent document 2, deletion of the data element from the data structured as the list is executed by a CAS operation which executes a logical deletion and by a CAS operation which executes a physical deletion. Then, by providing a mark bit representing the data element which has not been deleted physically although it has been deleted logically, intervention of other instructions during processing of a delete instruction is prevented. The deletion of the data element means that a memory area assigned to record information possessed by the data element is made to be released and put into an unused state. A released memory area will be in a reusable state.

On the other hand, a RCU (Read-Copy Update) algorithm disclosed in U.S. Pat. No. 5,442,758 executes deletion of a data element from list-structured data by a deleting phase corresponding to deletion disclosed in non-patent document 2 and a re-setting phase to change an deleted data element into the reusable state.

### SUMMARY OF INVENTION

In non-patent document 2, it is assured that a deletion thread which deletes the data element from list-structured data is processed properly. However, it is not assured that a thread which has begun before starting of the deletion thread and accesses the data element to be deleted is processed properly. The reason of this is that a memory area having been assigned to the data element will be in a reusable state after a physical deletion has been performed. The reusable state means a state that, even if different information is written in the memory area, it does not adversely affect another thread which handles the list-structured data to which the data element has belonged to before. When a deleted data element comes to be in a reusable state and its content is rewritten, a thread which accesses the deleted data element, having been started before starting of a deletion thread, accesses the rewritten data element badly. Accordingly, there is a problem that this thread may not be processed properly.

On the other hand, according to U.S. Pat. No. 5,442,758, whether or not an element having been deleted from a list is reusable and transferable to a re-setting phase is determined. Therefore, being rewritten the content of the data element can be prevented during execution of the thread which accesses the data element to be deleted, the thread being started before the start of the deletion thread. However, a determination of whether it is possible or not to shift to the re-setting phase is executed by confirming that all processors have performed process switchover after completion of the deleting phase. Accordingly, there is a problem that, even if a data element that has been deleted becomes in a reusable state actually, the data element comes to be able to be reused long after it has been deleted.

For example, it is conceivable to settle the above-mentioned problem by performing information exchange in inter-thread communication. However, in a case where a lot of deletion threads and a lot of search threads which access data elements are being executed in parallel, overhead will be large and management will be complex.

An object of the present invention is to provide a technology which settles the above-mentioned problems as a main object.

### SOLUTION TO PROBLEM

One aspect of the present invention is an information processing apparatus, including:

thread control means for, at starting a plurality of threads, giving an identifier to the thread, and, at ending the each thread, notifying of an end along with the identifier; and

data element control means for, in case that a deletion thread which deletes a data element from list-structured data being executed, maintaining a content of the deleted data element in an unmodifiable state until ends of all the threads which started before the deletion processing by the deletion thread being confirmed by a notification of the end along with the identifier, and, in case that the ends of all the threads which started before the deletion processing by the deletion thread being notified of along with the identifier, putting the deleted data element into a reusable state.

Further, the present invention provides an information processing system, including:

processing means for executing a search thread which searches for list-structured data and a deletion thread which deletes a data element from list-structured data; and

processing state management means for managing execution of a plurality of threads by the processing means, wherein

the processing state management means includes:

state holding means for holding a maximum sequence number being an identifier given to the thread which is started lastly, a minimum sequence number being a sequence number of the thread before which all the threads ended, and sequence number management data including information indicating a start and an end of the each thread,

start-and-end processing means including a start processing unit which gives the sequence number uniquely increased to the thread which is started, and an end processing unit which reflects completion of the thread corresponding to the sequence number in the sequence number management data, and

end determination means including a maximum sequence number acquisition unit which acquires the maximum sequence number from the state holding means in response to a request from the deletion thread and returns the maximum sequence number, and a minimum sequence number comparison unit which compares the maximum sequence number acquired from the deletion thread and the minimum sequence number held by the state holding means, wherein

calls the start processing unit at starting search processing by the search thread, and calls the end processing unit at ending search processing by the search thread, and by calling the maximum sequence number acquisition unit and the minimum sequence number comparison unit after deletion processing of the data element by the deletion thread, determines whether the data element deleted by the deletion thread is reusable or not.

Still further, the present invention provides an information processing method, including:

giving, at starting a plurality of threads, an identifier to each thread;

notifying, at ending of the each thread, of the end along with the identifier;

in case that a deletion thread which deletes a data element from list-structured data being executed, maintaining a content of the deleted data element in an unmodifiable state until the ends of all the threads which started before a deletion processing by the deletion thread being confirmed by a notification of the end along with the identifier; and

in case that the ends of all the threads which started before the deletion processing by the deletion thread being notified of along with the identifier, putting the deleted data element into a reusable state.

Meanwhile, this object is also achieved by a computer program which realizes an information processing apparatus and a data processing method having aforementioned constitution by a computer, and a computer-readable storage medium in which the computer program is stored.

### ADVANTAGEOUS EFFECTS OF INVENTION

According to the present invention, there is obtained an effect that, the deleted data element can be put into the reusable state quickly without the running threads being affected by the deletion of the data element from data structured as a list.

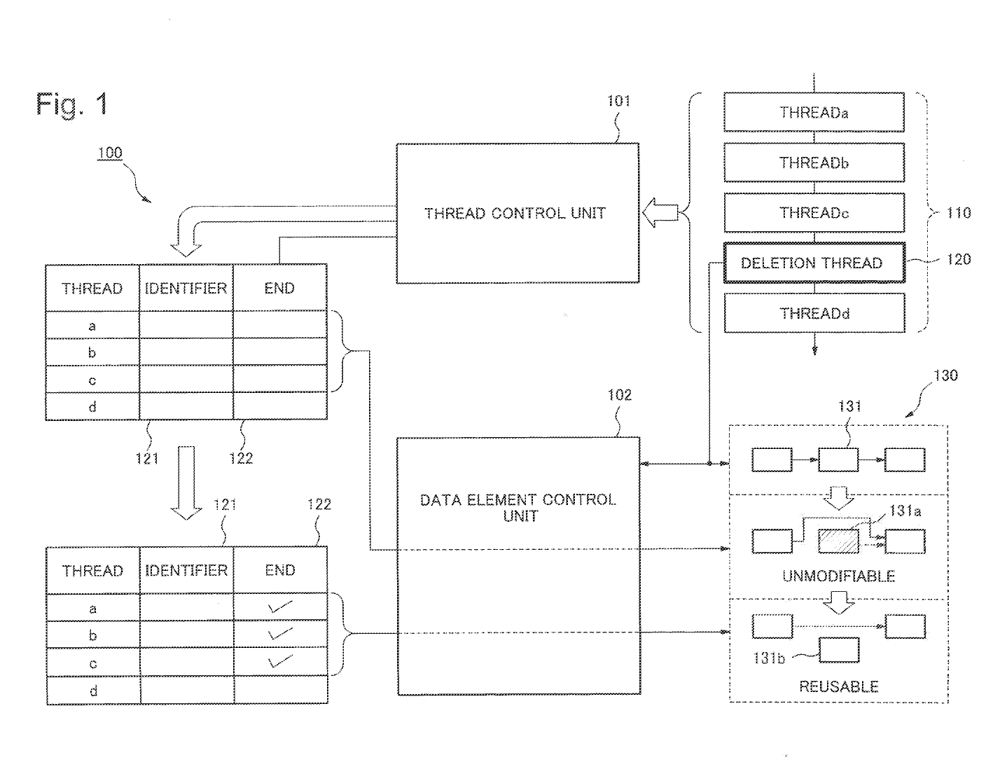

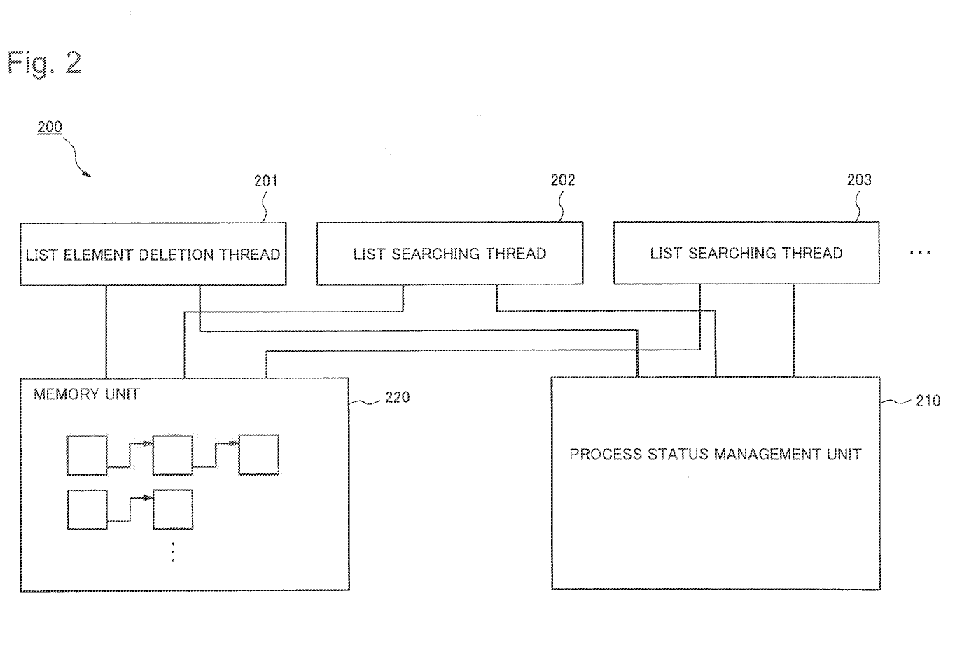

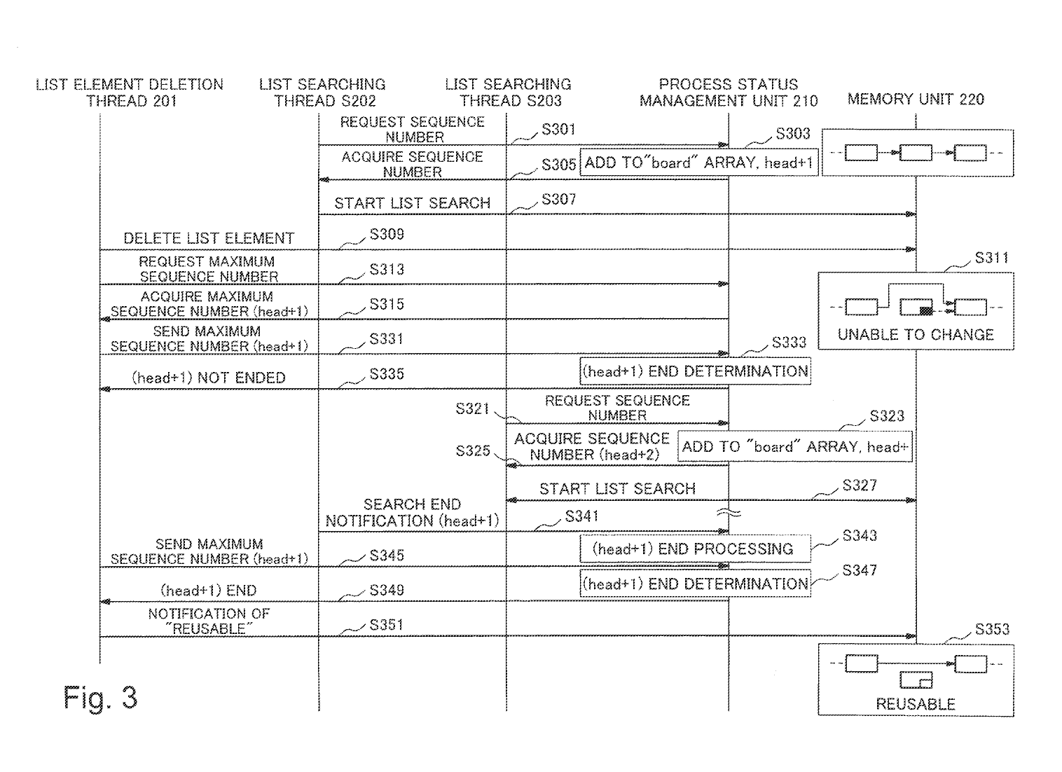

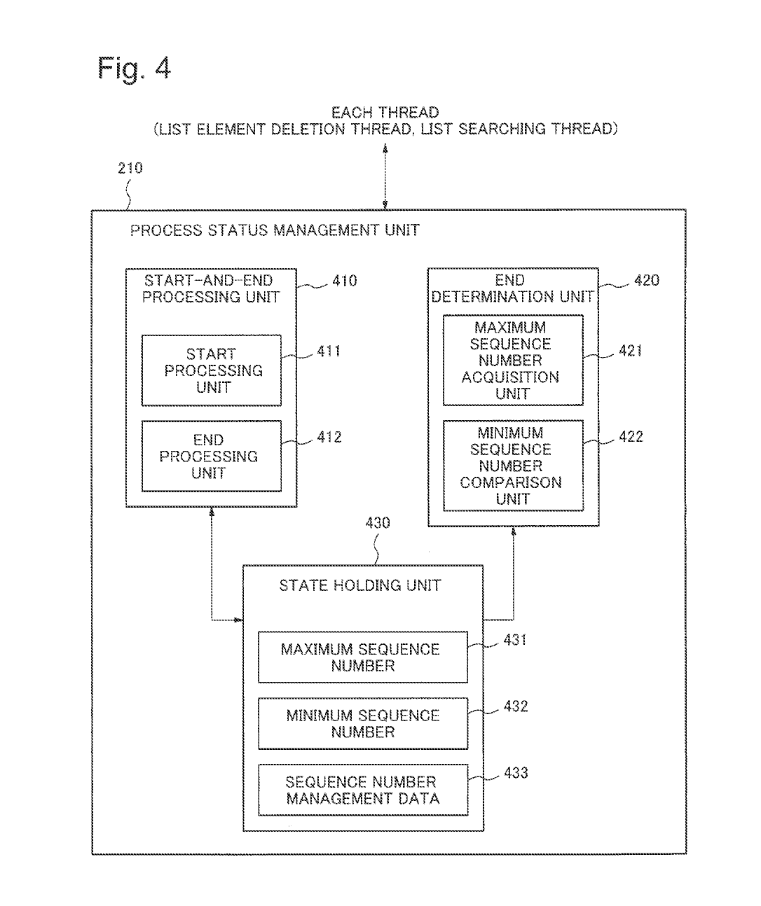

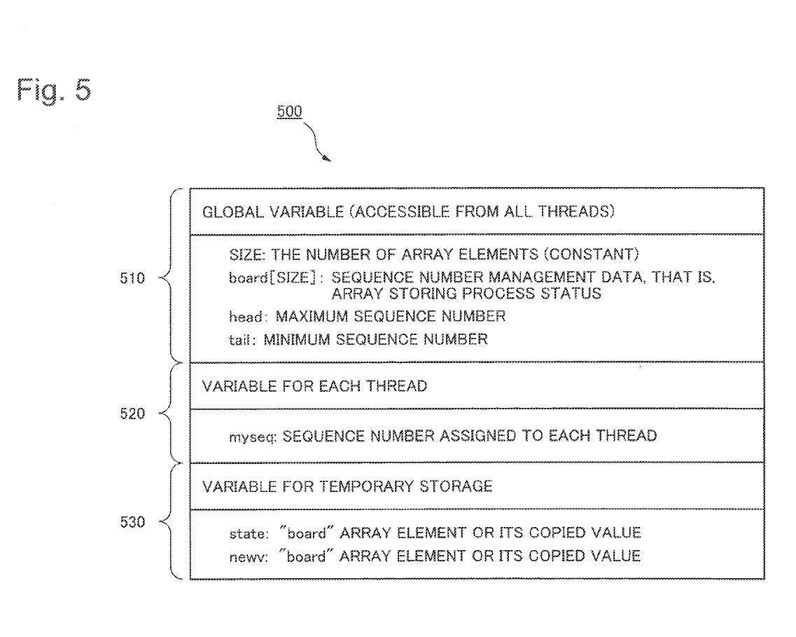

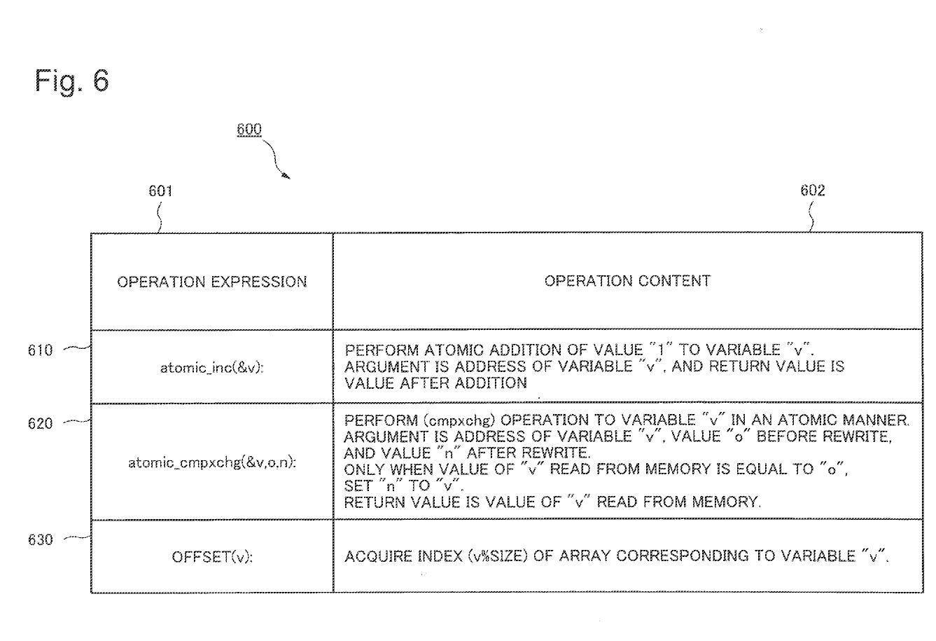

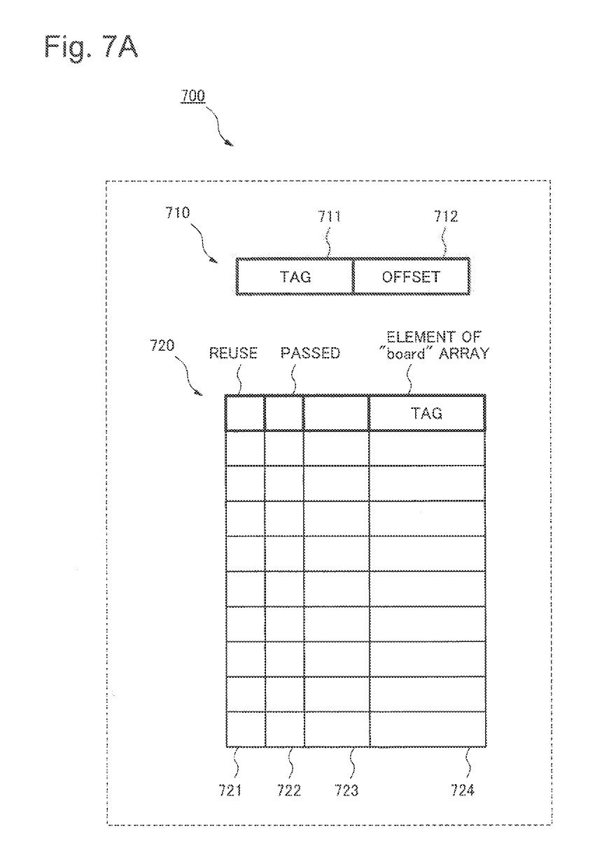

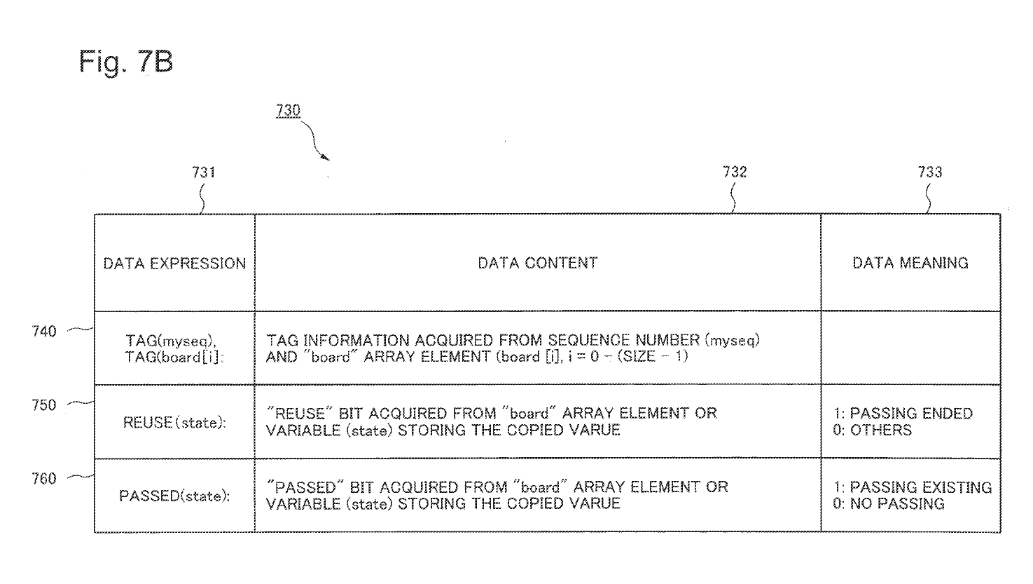

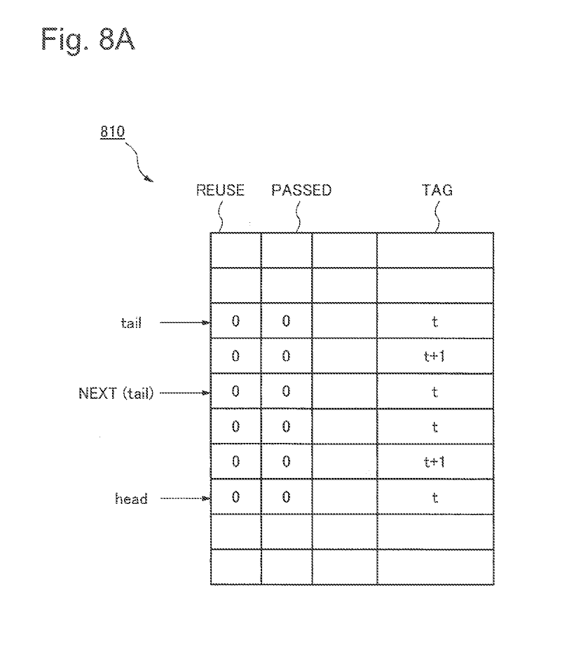

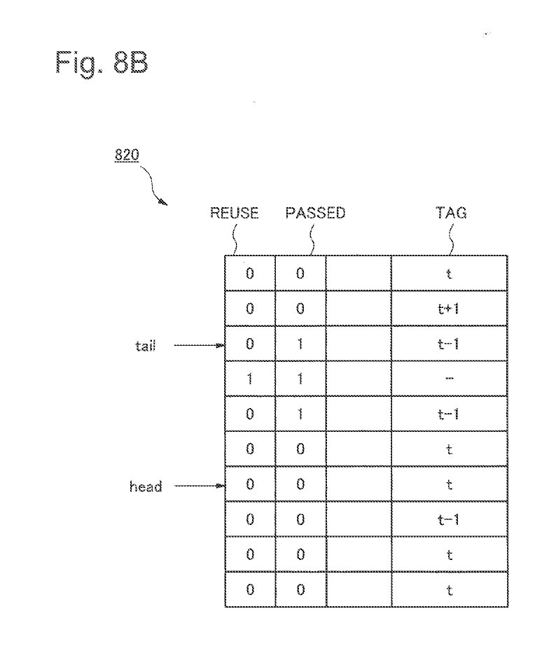

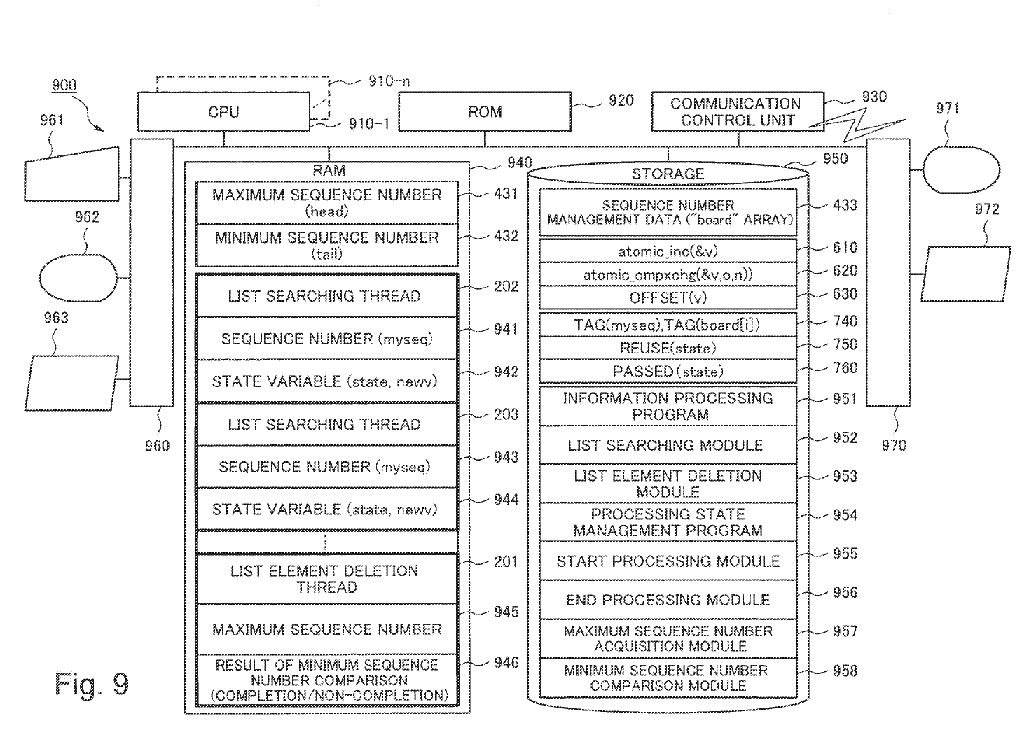

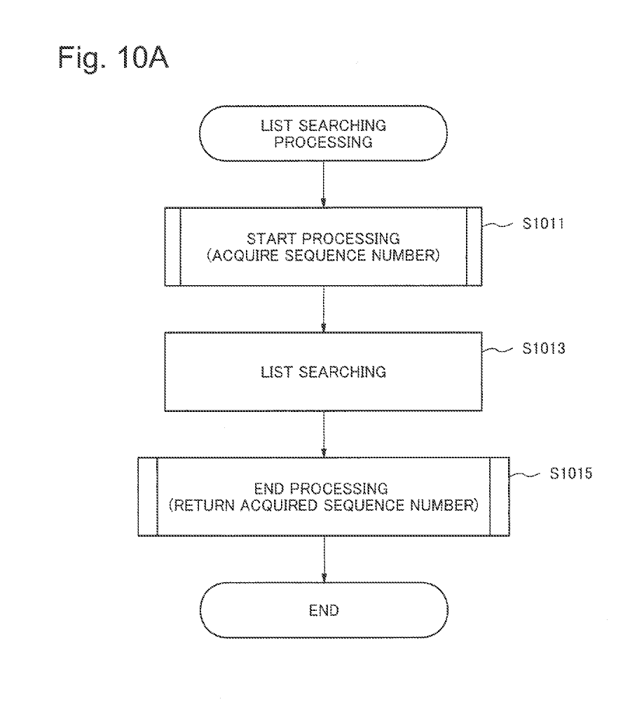

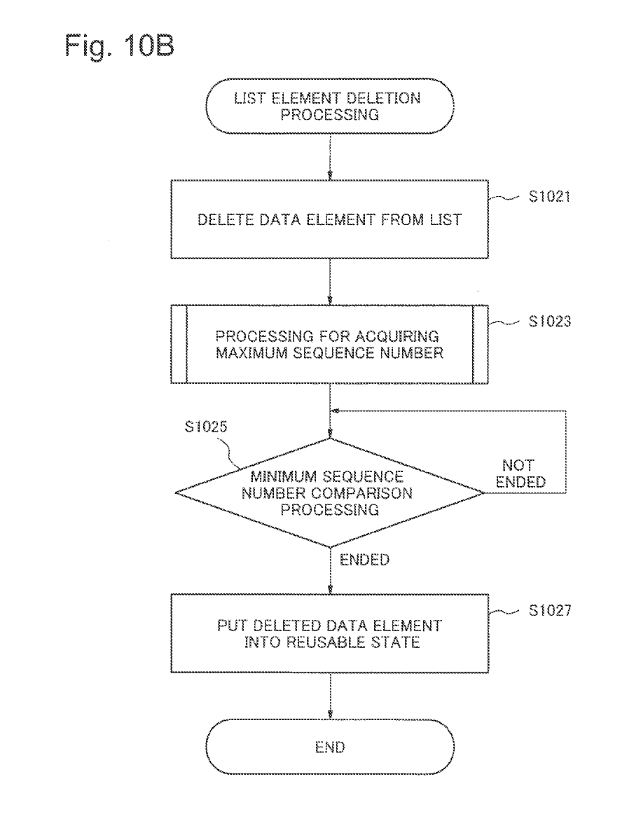

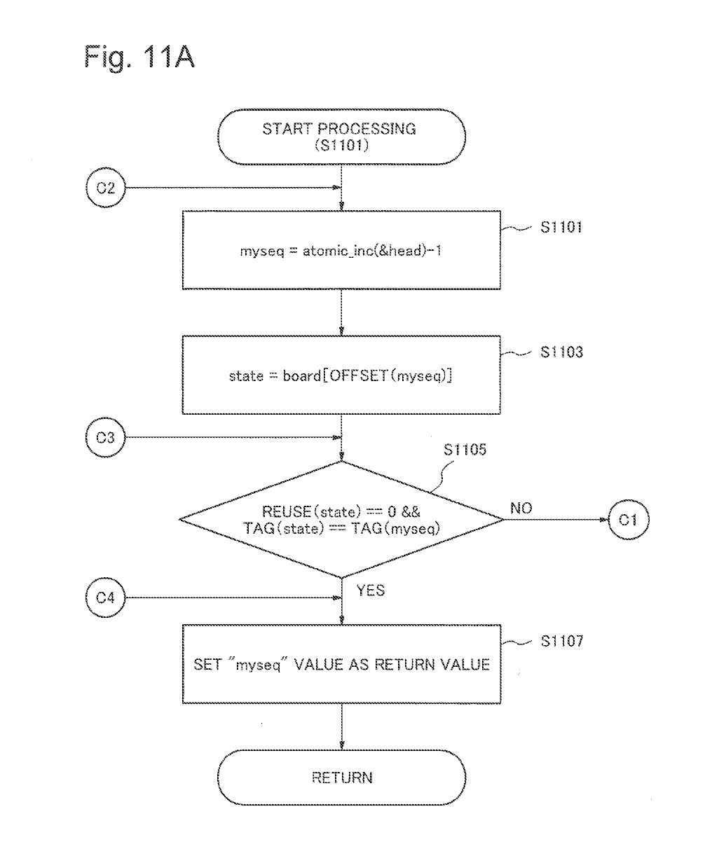

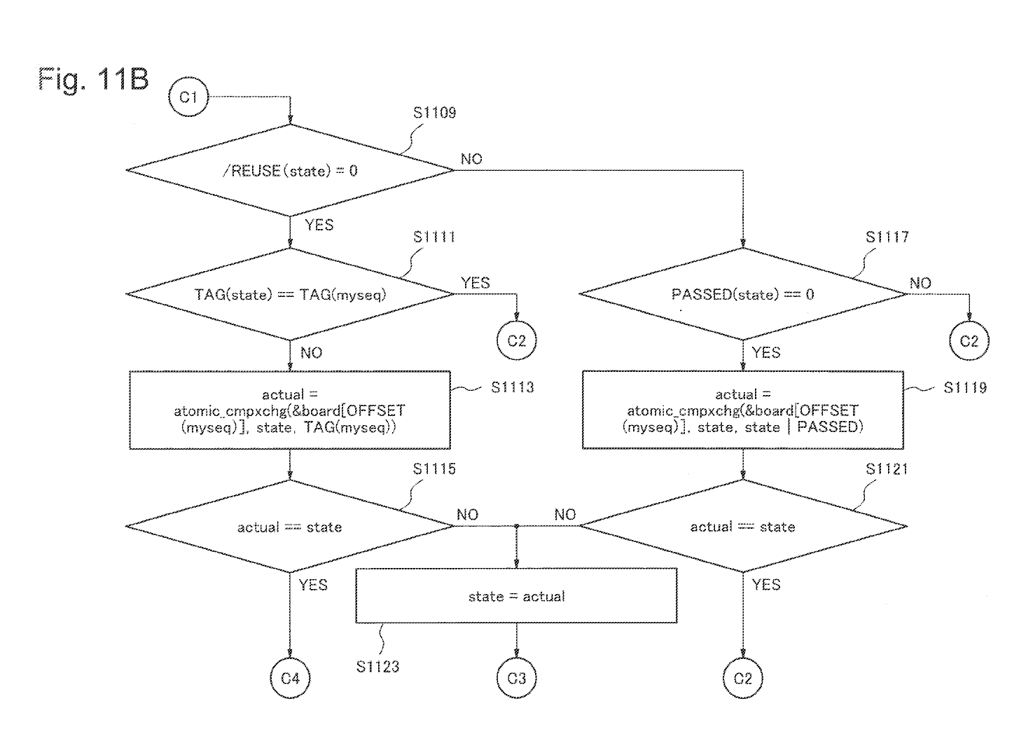

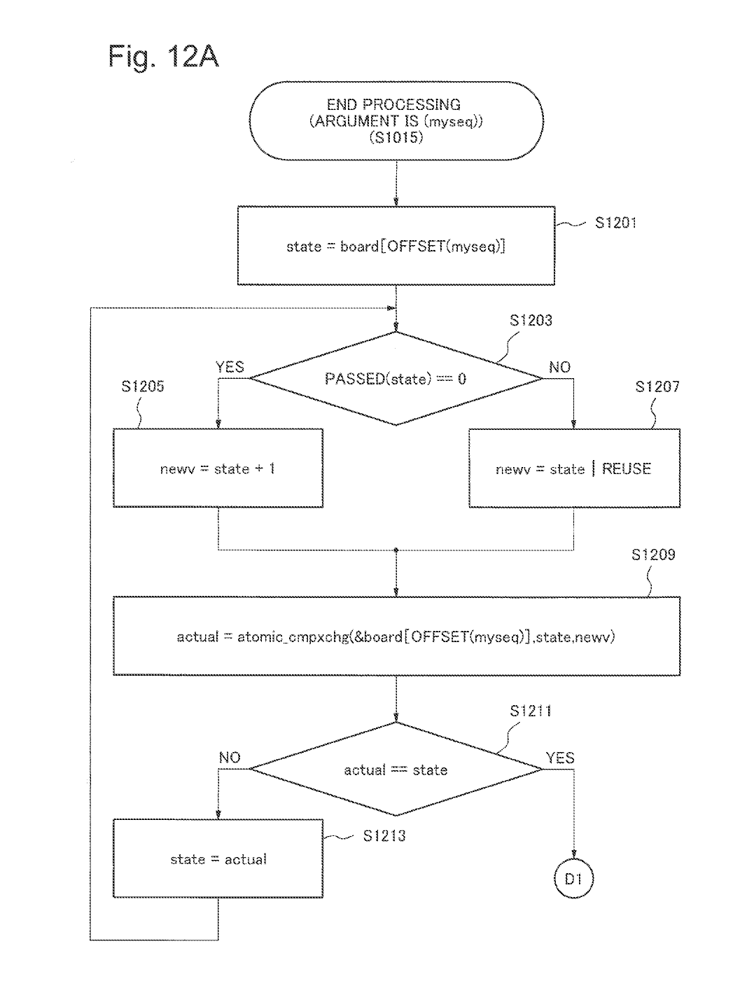

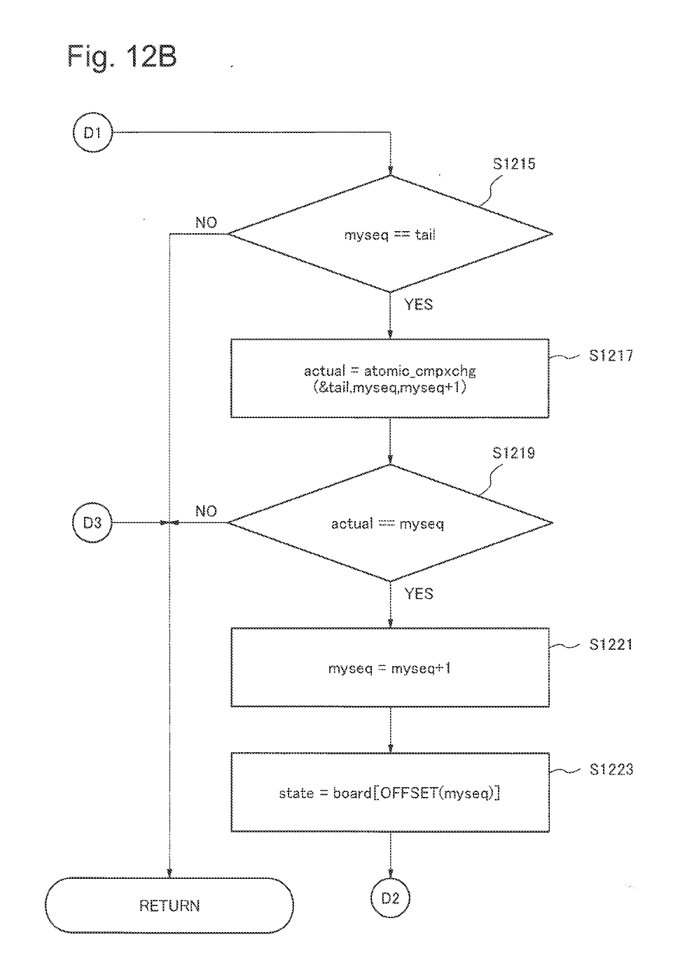

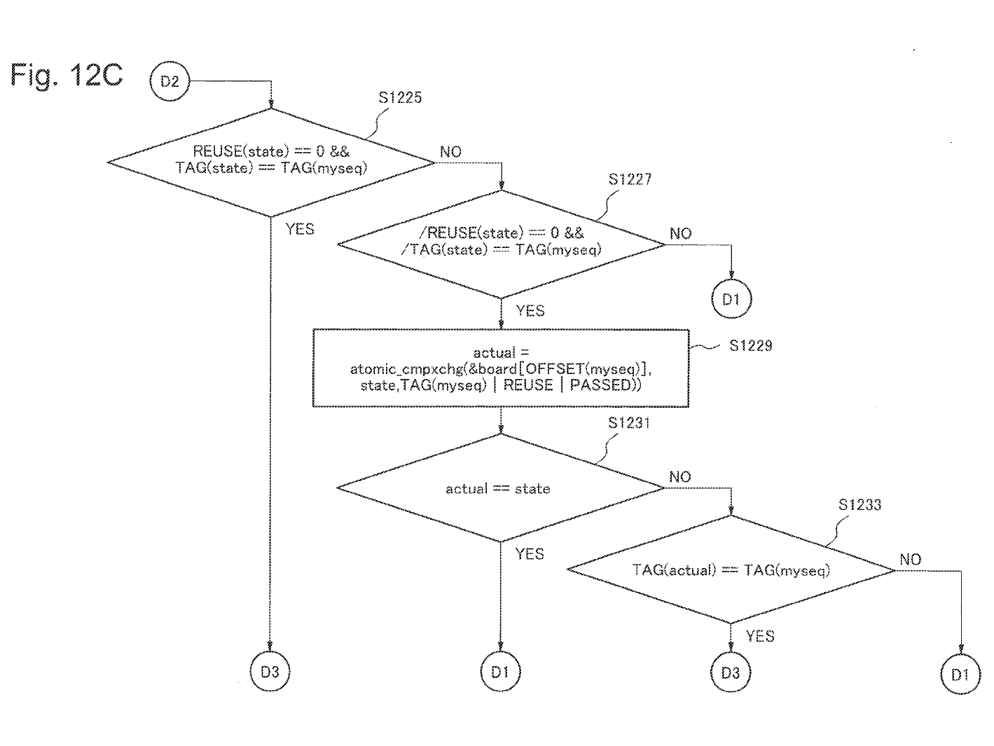

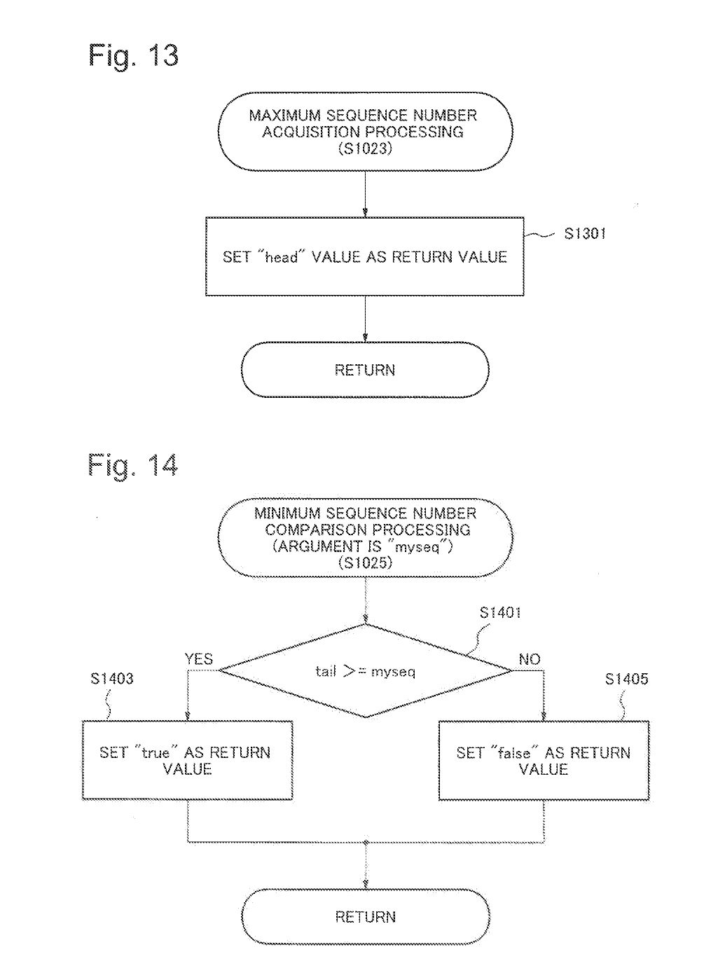

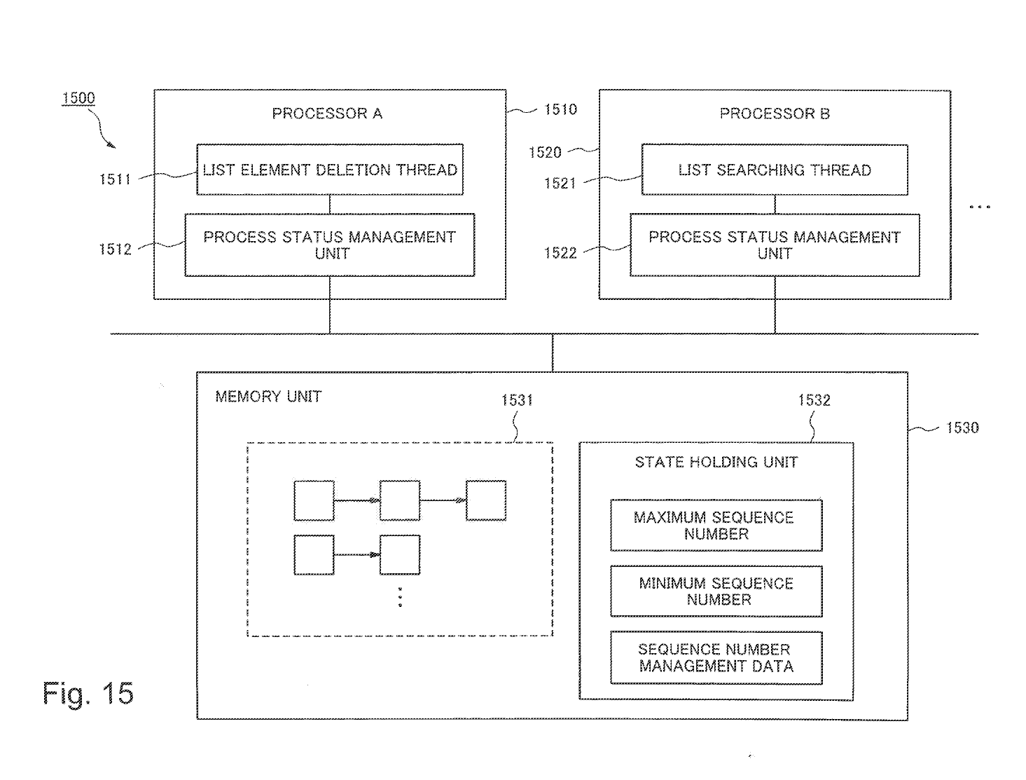

### BRIEF DESCRIPTION OF DRAWINGS

[FIG. 1] FIG. 1 is a block diagram showing a structure of an information processing system according to a first exemplary embodiment of the present invention.

[FIG. 2] FIG. 2 is a block diagram showing a structure of an information processing system according to a second exemplary embodiment of the present invention.

[FIG. 3] FIG. 3 is a sequence diagram showing an operation procedure of an information processing system according to the second exemplary embodiment of the present invention.

[FIG. 4] FIG. 4 is a block diagram showing a structure of a process status management unit according to the second exemplary embodiment of the present invention.

[FIG. 5] FIG. 5 is a diagram showing a definition of variables used in the second exemplary embodiment of the present invention.

[FIG. 6] FIG. 6 is a diagram showing a definition of operation used in the second exemplary embodiment of the present invention.

[FIG. 7A] FIG. 7A is a diagram showing a data structure used in the second exemplary embodiment of the present invention.

[FIG. 7B] FIG. 7B is a diagram showing data expression used in the second exemplary embodiment of the present invention.

[FIG. 8A] FIG. 8A is a diagram showing an exemplary configuration of a “board” array according to the second exemplary embodiment of the present invention.

[FIG. 8B] FIG. 8B is a diagram showing another exemplary configuration of “board” array according to the second exemplary embodiment of the present invention.

[FIG. 9] FIG. 9 is a block diagram showing a hardware configuration of an information processing apparatus according to the second exemplary embodiment of the present invention.

[FIG. 10A] FIG. 10A is a flow chart showing a processing procedure of a list searching thread of an information processing apparatus according to the second exemplary embodiment of the present invention.

[FIG. 10B] FIG. 10B is a flow chart showing a processing procedure of a list element deletion thread of an information processing apparatus according to the second exemplary embodiment of the present invention.

[FIG. 11A] FIG. 11A is a flow chart showing a processing procedure of start processing according to the second exemplary embodiment of the present invention.

[FIG. 11B] FIG. 11B is a flow chart showing a processing procedure of start processing according to the second exemplary embodiment of the present invention.

[FIG. 12A] FIG. 12A is a flow chart showing a processing procedure of end processing according to the second exemplary embodiment of the present invention.

[FIG. 12B] FIG. 12B is a flow chart showing a processing procedure of end processing according to the second exemplary embodiment of the present invention.

[FIG. 12C] FIG. 12C is a flow chart showing a processing procedure of end processing according to the second exemplary embodiment of the present invention.

[FIG. 13] FIG. 13 is a flow chart showing a processing procedure of maximum sequence number acquisition processing according to the second exemplary embodiment of the present invention.

[FIG. 14] FIG. 14 is a flow chart showing a processing procedure of minimum sequence number comparison processing according to the second exemplary embodiment of the present invention.

[FIG. 15] FIG. 15 is a block diagram showing a structure of an information processing system according to a third exemplary embodiment of the present invention.

### DESCRIPTION OF EMBODIMENTS

Exemplary embodiments of the present invention will be described in detail exemplarily with reference to a drawing below. In this regard, however, components indicated in the following exemplary embodiments are just illustration, and not intend to limit the technological scope of the present invention to only those.

### First Exemplary Embodiment

An information processing apparatus 100 as the first exemplary embodiment of the present invention will be described using FIG. 1. The information processing apparatus 100 is constituted such that a plurality of threads are executed in parallel.

As shown in FIG. 1, the information processing apparatus 100 includes a thread control unit 101 and a data element control unit 102. At starting a plurality of threads 110, the thread control unit 101 gives an identifier 121 to each thread, and, at ending the each thread, notifies of the end 122 along with the identifier 121. In case that a deletion thread 120 which deletes a data element 131 from list-structured data 130 is executed, the data element control unit 102 operates as follows. That is, the data element control unit 102 maintains a content of the deleted data element 131 in an unmodifiable state 131a until the ends of all the threads a-c which started before the deletion processing by the deletion thread 120 are confirmed by the notification of the end 122 along with the identifier 121. The data element control unit 102 ,in case the ends of all the threads a-c which started before the deletion processing by the deletion thread 120 are notified of along with the identifier 121, puts the deleted data element 131 into a reusable state 131b.

The thread control unit 101 corresponds to a start-and-end processing unit 410 and a state holding unit 430 in the following exemplary embodiments, and the data element control unit 102 corresponds to an end determination unit 420 likewise.

Here, putting the data element into a reusable state means that a memory area that is assigned to record information possessed by the data element is made to be released and put into an unused state.

According to this exemplary embodiment, the deleted data element can be put into the reusable state quickly without the running threads being affected by the deletion of the data element from data structured as a list.

### Second Exemplary Embodiment

Next, an information processing system according to the second exemplary embodiment of the present invention will be described. In this exemplary embodiment, an information processing system includes a process status management unit which manages a processing state in response to a start and an end of each processing thread. The process status management unit puts a deleted data element into a reusable state quickly without the running threads being affected in the deletion processing by a list element deletion thread which deletes a data element from list-structured data.

According to this exemplary embodiment, the process status management unit manages a plurality of processing threads. As a result, it could be possible to put the deleted data element into a reusable state quickly without the running threads being affected by the deletion of the data element from the list-structured data.

Structure of Information Processing System

FIG. 2 is a block diagram showing a structure of an information processing system 200 according to this exemplary embodiment. The information processing system 200 includes a memory unit 220 and a process status management unit 210.

In FIG. 2, a list element deletion thread 201 is a thread including processing to delete a data element from list-structured data. List searching threads 202 and 203 are representing threads including processing of accessing list-structured data. Any CPU (central processing unit) of any processor included in the information processing system 200 may begin and execute these threads. In this regard, however, in the following description of the second exemplary embodiment, a case where one processor executes threads in parallel way will be explained in order to describe concisely.

The process status management unit 210 manages processing states of the threads by executing processing in response to a start and an end of each of the above-mentioned threads 201-203 (refer to FIG. 4). The memory unit 220 stores data including list-structured data. Meanwhile, the memory unit 220 may be a main memory (RAM (random access memory)) in a single processor, or may be a storage (disk etc.), for example. The memory unit 220 may be configured in a manner distributed in a plurality of processors, or may be configured so that it may be shared in the information processing system 200.

Operation Procedure of Information Processing System

FIG. 3 is a sequence diagram showing an operation procedure of the information processing system 200 according to this exemplary embodiment. With reference to FIG. 3, the outline of an operation procedure of the information processing system 20 will be described. Although FIG. 3 indicates communications between the elements shown in FIG. 2, there is no limitation on the number of threads which are processed in parallel. Also, in FIG. 3, in order to make a flow clear as a whole, indication of a dialogue between pieces of small processing will be omitted. The starting sequence of the each thread is as follows. That is, first, the list searching thread 202 starts processing, and then, the list element deletion thread 201 starts processing, and, finally, the list searching thread 203 starts processing.

First, the list searching thread 202 that has started first requests its sequence number to the process status management unit 210 in Step S301. The process status management unit 210 adds a start of a new thread to a “board” array which manages a thread (refer to FIG. 7A), and adds 1 to a starting position pointer (head: hereinafter, it is also referred to as a maximum sequence number) in the “board” array in Step S303. Then, the process status management unit 210 returns the sequence number (head+1) to the list searching thread 202 in Step S305. The list searching thread 202 starts a list searching processing and searches for list-structured data stored in the memory unit 220 in Step S307.

Next, the list element deletion thread 201 starts its processing, and deletes a data element from the list-structured data in the memory unit 220 in Step S309. The deletion processing may be executed by operation disclosed in non-patent documents 1 or 2 involving CAS operation like Step S311. In this regard, however, at this point, the list element deletion thread 201 maintains the deleted data element in a non-reusable state, that is, in the state that the content of the deleted data element is unmodifiable. The list element deletion thread 201, in Step S313 which is the point of the completion of deletion processing, requests the present maximum sequence number to the process status management unit 210. The process status management unit 210 returns the present maximum sequence number (in this case, head+1) to the list element deletion thread 201 in Step S315.

Next, in Step S331, the list element deletion thread 201 sends the received maximum sequence number (head+1) to the process status management unit 210, and inquires of it whether a thread having the maximum sequence number (head+1) has ended or not. In Step S333, the process status management unit 210 determines whether the thread having the maximum sequence number (head+1) has ended based on data in the “board” array. In this example, the list searching thread 202 has just started and it has not ended yet. Accordingly, in Step S335, the process status management unit 210 notifies the list element deletion thread 201 of non-completion of the thread having the maximum sequence number (head+1). Therefore, the deleted data element is maintained in non-reusable and so that its content is maintained in unmodifiable.

The list searching thread 203 that has started finally, first, requests its sequence number to the process status management unit 210 in Step S32. In Step S323, the process status management unit 210 adds the start of the new thread to the “board” array which manages threads, and adds 1 to the starting position pointer of the “board” array (in FIG. 3, it is indicated as “head+2” in order to make the processing clear). Then, in Step S325, the process status management unit 210 returns the sequence number (head+2) to the list searching thread 203. The list searching thread 203 starts list searching processing in Step S327, and searches for list-structured data stored in the memory unit 220. Meanwhile, timing of starting of the list searching thread 203 is not limited to the timing shown in FIG. 3, if it is after the deletion of a data element by the list element deletion thread 201.

The list element deletion thread 201 repeats Steps S331-S335 in a predetermined time interval. In other words, the list element deletion thread 201 sends the maximum sequence number to the process status management unit 210 in the predetermined time interval, and inquires of the process status management unit 210 whether all the threads up to the list searching thread 202 have ended or not. In FIG. 3, unless the list searching thread 202 reports the end of its processing to the process status management unit 210, it will not be in the completion status of all the threads before the deletion. Therefore, the content of the deleted data element is maintained until a report of the above-mentioned completion.

In Step S341, the list searching thread 202 completes its processing, and reports the end of the processing to the process status management unit 210. In Step S343, the process status management unit 210 performs completion processing of the list searching thread 202 to which the sequence number (head+1) has been given. In Step S345, the list element deletion thread 201 sends the maximum sequence number (head+1). Then, the list element deletion thread 201 sends an inquiry to the process status management unit 210 about whether all the threads up to the list searching thread 202 have ended or not. At this point, the process status management unit 210 determines that the list searching thread 202 has ended (in reality, the process status management unit 210 determines that all the threads which have started before the deletion of the list element deletion thread 201 have ended), in Step S347. Then, in Step S349, the process status management unit 210 notifies the list element deletion thread 201 of the end of the thread having the maximum sequence number (head+1).

Upon receiving the notice of the end of the thread having the maximum sequence number (head+1), the list element deletion thread 201 informs the memory unit 220 that the deleted data element is reusable, in Step S351. As shown in Step S353, the process status management unit 210 puts the data element deleted by the list element deletion thread 201 from the list-structured data into reusable to the memory unit 220 at this point. That is, by releasing the memory area which is assigned to record the information possessed by the deleted data element, the process status management unit 210 puts the memory area into an unused state.

By such operation procedure, the content of the data element deleted by the list element deletion thread 201 from the list-structured data is maintained until all the threads that have started before deletion processing by the list element deletion thread 201 end. When the target threads end, the data element which has been deleted becomes reusable immediately. Meanwhile, in the above mentioned description, although the ends of all the threads that have begun before deletion processing of the list element deletion thread 201 are made be a condition, ends of threads which do not access the list-structured data are not needed to be waited. Therefore, additional control according to the content of processing of a thread is also possible. In that case, it is possible to make an deleted data element be reusable further earlier.

Structure of Process Status Management Unit

FIG. 4 is a block diagram showing a structure of the process status management unit 210 according to this exemplary embodiment.

The process status management unit 210 includes the start-and-end processing unit 410, the end determination unit 420 and the state holding unit 430. The start-and-end processing unit 410 includes a start processing unit 411 and an end processing unit 412. The end determination unit 420 includes a maximum sequence number acquisition unit 421 and a minimum sequence number comparison unit 422. The state holding unit 430 holds a maximum sequence number 431 that is a sequence number given to the latest thread, a minimum sequence number 432 which is a sequence number of a thread about which all the threads before the thread have ended, and sequence number management data 433 for managing sequence numbers which have been already given and already processed.

These functional components are called by a thread processing unit respectively with an argument, and return a return value to the thread processing unit after performing processing. The summary of such processing will be described below.

By referring to and updating the maximum sequence number 431 and the sequence number management data 433, the start processing unit 411 gives a sequence number to a calling thread. The end processing unit 412 receives a sequence number from a calling thread. Then, the end processing unit 412 refers to and updates the maximum sequence number 431, the minimum sequence number 432 and the sequence number management data 433, and reflects the sequence number of which processing has completed in the minimum sequence number 432.

The maximum sequence number acquisition unit 421 gives the maximum sequence number 431 at the time of being called to a calling thread. The minimum sequence number comparison unit 422 compares a sequence number which has been given from a calling thread and the minimum sequence number 432, and notifies the calling thread of whether a thread corresponding to the sequence number is completed or not.

In this exemplary embodiment, a list searching thread which searches for list structural data receives a sequence number corresponding to search processing by calling the start processing unit 411 at the time of starting of the search process. A list searching thread also calls the end processing unit 412 when the search processing is ended by using a sequence number corresponding to the search processing as an argument.

The list element deletion thread which deletes a data element from a list structure calls the maximum sequence number acquisition unit 421 after executing an atomic memory access which physically deletes a data element from list structure data. As a result, the list element deletion thread acquires the maximum sequence number 431 at that point. After that, by calling the minimum sequence number comparison unit 422 using this sequence number as an argument, the list element deletion thread examines whether a thread corresponding to the sequence number is completed or not. As a result, the list element deletion thread determines whether the deleted data element is reusable or not.

By the above mentioned structure, there is obtained an effect that, immediately after search processing by a list searching thread has end, the list searching thread having a possibility of referring to a data element that has been deleted by a list element deletion thread, it is possible to recognize that the data element is reusable. In addition, because the notification about completion of list searching processing is performed via the process status management unit 210, it is not necessary that a list searching thread and a list element deletion thread communicate with each other directly. Accordingly, there is obtained an effect that an overhead of a system is suppressed and management can be prevented from becoming complex.

Although a summary of the operation procedure of the process status management unit 210 has been described above, the operation procedure of the process status management unit 210 will be described more in detail below.

Definition of Variables

FIG. 5 is a diagram showing a definition 500 of variables used in this exemplary embodiment.

In this exemplary embodiment, the maximum sequence number 431, the minimum sequence number 432 and the sequence number management data 433 that are stored in the state holding unit 430 are variables accessible from all the threads, respectively. As shown by 510, the respective variables are expressed as “head”, “tail” and “board” [SIZE]. Further, a fixed number that indicates the number of array elements of sequence number management data which is an array is expressed as SIZE. As shown by 520, a variable that stores a sequence number assigned to a thread (it is expressed as “myseq”) is prepared as a variable for each thread. Further, as shown by 530, as variables for temporary storage, variable (state) and variable (newv) that are “board” array element or their copied value are prepared.

Definition of Operation

FIG. 6 is a diagram showing an operation definition 600 used in this exemplary embodiment. The operation definition 600 includes an operation expression 601 and operation content 602.

In this exemplary embodiment, as basic operation, the following three kinds of operations are executed. That is, operation 610 which performs atomic addition of a numerical value “1” to variable “v”, operation 620 which execute “cmpxchg” operation in an atomic manner to variable “v”, and operation 630 which acquires index (v % SIZE) of an array corresponding to variable “v”. They are expressed as “atomic_inc (&v)”, “atomic_cmpxchg (&v, o, n)” and “OFFSET (v)”, respectively.

Data Structure

FIG. 7A is a diagram showing data formation 700 used in this exemplary embodiment.

As shown in FIG. 7A, a sequence number 710 includes: lower bits 712 used as an OFFSET value corresponding to an index of a “board” array; and a higher bit 711 which is used as TAG information to be stored in the “board” array. In addition, each element in a “board” array 720 that corresponds to the sequence number management data 433 stores TAG information 724, REUSE 721 and PASSED 722. The PASSED 722 is an one-bit flag which shows that the thread having a sequence number corresponding to the array element has been passed because that thread is not yet completed (detailed description will be made later). The REUSE 721 is one-bit flag which shows that the thread having a sequence number corresponding to the array element to which passing has been performed has ended (detailed description will be made later). Numeral 723 indicates option bits that can be used for other purposes, and is not used in this exemplary embodiment. Here, the “board” array 720 is limited in the prescribed address area. A new array element is arranged so that it may circle the address area of the “board” array 720. That is, the process status management unit 210 calculates an address from the starting order of the thread, and holds the state of the running thread in that address.

Data Expression

FIG. 7B is a diagram showing a data expression 730 used in this exemplary embodiment. The data expression 730 includes data content 732 and a data meaning 733 associated with a data expression 731.

A TAG (myseq) and TAG (board [i]) 740 indicates TAG information acquired from sequence number (myseq) and “board” array element (board [i], i=0−(SIZE−1)). A REUSE (state) 750 indicates a REUSE bit which has been acquired from the variable (state) that stores a value of the “board” array element or its copied value. A PASSED (state) 760 indicates a PASSED bit which has been acquired from the variable (state) that stores a value of the “board” array element or its copied value.

“Board” Array

With reference to FIG. 8A and FIG. 8B, exemplary configurations of the “board” array 720 shown in FIG. 7A will be described. Meanwhile, these two examples are the characteristic examples, and the structure and operations of the “board” array 720 can be understood from this example.

FIG. 8A is a diagram showing an exemplary configuration 810 of the “board” array 720 according to this exemplary embodiment. FIG. 8A is an example of a “board” array in a situation that OFFSET (head) does not pass OFFSET (tail). Here, “t” is TAG (head).

Now, description about passing will be made. As mentioned above, the “board” array 720 is limited in the prescribed address area.

Therefore, when “board” array elements for which end processing is uncompleted increase, the address area of the “board” array 720 is occupied by “board” array elements for which end processing is uncompleted. Accordingly, an “board” array element corresponding to “head” which is incremented by calling the start processing unit 411 is arranged such that it circles the address area of the “board” array 720. At that time, it is called that OFFSET (head) “passes” OFFSET (tail). Passing means an event that a “board” array element corresponding to “head” which is incremented by calling the start processing unit 411 has been in a state that its end processing is uncompleted.

In a situation that OFFSET (head) has passed OFFSET (tail), a difference between “head” and “tail” is beyond SIZE. In this case, the entire elements of the “board” array are being used. When OFFSET (head) passes OFFSET (tail), the PASSED bit of that array element is set. Then, when the end processing of the thread having the sequence number corresponding to the array element is completed, the REUSE bit of the array element is set.

As shown in FIG. 8A, in a situation where there is no passing, areas used by the “board” array, that is, a REUSE bit and a PASSED bit of array elements from OFFSET (tail) to OFFSET (head) are in a state that they are reset (it is expressed as “0” in the Figure). Also, TAG is “t” or “t+1”. Here, that a TAG value is “t” means that a sequence number given by the start processing unit 411 has not been returned, that is, the end processing unit 412 taking the sequence number as an argument has not been called. On the other hand, that a TAG value is “t+1” means that a sequence number given by the start processing unit 411 has been returned, that is, the end processing unit 412 that takes the sequence number as an argument has been called. Here, a movement of “tail” will be described. When the end processing unit 412 taking a sequence number equal to “tail” as an argument is called, TAG of the “board” array element (board [OFFSET {tail}]) corresponding to the sequence number of “tail” is changed to “t+1” from “t”. TAG of the “board” array element (board [OFFSET {tail+1}], which is in the row just under “tail” in FIG. 8A) corresponding to the sequence number of “tail+1” is “t+1” in FIG. 8A. This indicates that end processing has already completed. Therefore, by the end processing unit 412, “tail” is moved to a position of “tail+2” (it is expressed as “next tail” in FIG. 8A) that is the smallest number for which end processing has not completed at that point.

FIG. 8B is a diagram showing another exemplary configuration 820 of a “board” array according to this exemplary embodiment. FIG. 8B indicates a situation that OFFSET (head) has passed OFFSET (tail), that is, a case when a difference between “head” and “tail” has become beyond SIZE. In this case, the entire elements of the “board” array are being used. Here, that the TAG values in elements from board[OFFSET (head+1)] to the array final element (board [SIZE−1]) is “t” (=TAG (head)) indicates that end processing taking a sequence number given by the start processing unit 411 as an argument has been performed. On the other hand, that the TAG value is “t−1” indicates that end processing which takes the sequence number given by the start processing unit 411 as an argument has not been performed.

As mentioned above, passing means the event that the “board” array element corresponding to “head” that has been incremented by calling the start processing unit 411 is in the state that the end n processing is uncompleted. At that time, the “board” array will be of an arrangement in the second round or later. In this case, the start processing unit 411 sets the PASSED bit of the array element (it is expressed as “1” in this figure), and after having added 1 to “head” executes the start processing unit 411 again. In this case, a sequence number corresponding to the array element is not given.

Also, when, in the area from the array first element (board[0]) to board[OFFSET (head)]what the TAG value is “t+1” (=TAG (head)+1) means that end processing taking the sequence number given by the start processing unit 411 as an argument has been performed. On the other hand, what the TAG value is “t” means that end processing taking the sequence number given by the start processing unit 411 as an argument has not been performed. Further, that the TAG value is “t−1” or less in this area indicates that the passing event has performed to that array element. That array element became to be the state that the PASSED bit has been set by the above-mentioned operation.

The end processing taking the sequence number as the argument, the sequence number corresponding to the array element for which this PASSED bit has been set to “1”, sets that the end processing of the thread having the sequence number corresponding to the array element has completed by setting the REUSE bit (it is expressed as “1” in the figure).

Such passing processing is performed similarly even in a situation that OFFSET (head) has passed OFFSET (tail) no smaller than twice, that is, when a difference between “head” and “tail” are no smaller than 2 times of SIZE.

Hardware configuration of information processing apparatus FIG. 9 is a block diagram showing a hardware configuration of an information processing apparatus 900 according to this exemplary embodiment. FIG. 9 indicates a hardware exemplary configuration which executes parallel thread processing and a process status management unit of this exemplary embodiment. In this regard, however, the configuration of FIG. 9 is only an example of this exemplary embodiment, and various forms such as a form in which a part of these pieces of data and programs are distributed while another part of them are shared by parallel thread processing and a process status management unit can be realized.

In FIG. 9, CPUs 910-1 to 910-n are processors for arithmetic control, and realize each functional component of the information processing apparatus 900 by executing a program. A ROM (read only memory) 920 stores fixed data and a program such as initial data and a program. A communication control unit 930 sends and receives data with other processors and communication terminals via a network.

A RAM 940 is a random access memory which the CPUs 910-1 to 910-n use as a work area for temporary storage. In the RAM 940, there is reserved an area for memorizing data required for realization of this exemplary embodiment. Numeral 431 is a maximum sequence number (head). Numeral 432 is a minimum sequence number (tail).

The RAM 940 stores the list searching threads 202 and 203 and the list element deletion thread 201 that are also shown in FIG. 2. Numeral 941 is a sequence number (myseq) of the list searching thread 202. Numeral 942 is a state variable (state, newv) of the list searching thread 202. Numeral 943 is a sequence number (myseq) of the list searching thread 203. Numeral 944 is a state variable (state, newv) of the list searching thread 203. Numeral 945 is a maximum sequence number which the list element deletion thread 201 has acquired. Numeral 946 is a result of the minimum sequence number comparison (completion/non-completion) which the list element deletion thread 201 has inquired.

In a storage 950, there are stored a database and various parameters, or the following data or programs required for realization of this exemplary embodiment. Numeral 610 is operation “atomic_inc (&v)” which is expressed by a function defined in FIG. 6. Numeral 620 is operation “atomic_cmpxchg (&v, o, n)” which is expressed by a function defined in FIG. 6. Numeral 630 is operation OFFSET (v) which is expressed by a function defined in FIG. 6. Numeral 740 are data TAG (“myseq”) and TAG (board[i]) which are expressed by a function defined in FIG. 7B. Numeral 750 is data REUSE (“state”) which is expressed by a function or a pointer defined in FIG. 7B. Numeral 760 is data PASSED (“state”) which is expressed by a function or a pointer defined in FIG. 7B.

The following programs are stored in the storage 950. Numeral 951 is an information processing program to be made to execute the whole processing. Numeral 952 is a list searching processing program which executes a list searching thread used in the information processing program 951 (refer to FIG. 10A). Numeral 953 is a list element deletion processing program which executes a list element deletion thread used in the information processing program 951 (refer to FIG. 10B). Meanwhile, only two threads are shown in FIG. 9, and programs corresponding to other threads are omitted.

Numeral 954 is a processing state management program which performs processing state management. Numeral 955 is a start processing module which executes start processing in the processing state management program 954, (refer to FIG. 11A and FIG. 11B). Numeral 956 is an end processing module which executes end processing in the processing state management program 954 (refer to FIGS. 12A to 12C). Numeral 957 is a maximum sequence number acquisition processing module which executes maximum sequence number acquisition processing in the processing state management program 954 (refer to FIG. 13). Numeral 958 is a minimum sequence number comparison processing module which executes a minimum sequence number comparison processing in the processing state management program 954 (refer to FIG. 14).

In FIG. 9, a list searching thread, a list element deletion thread and each module are illustrated such that they are processed in an intermingled manner. However, as shown in FIG. 2, it may be such that data and programs related to the process status management unit 210 are separated from data and programs related to data processing such as a list searching thread and a list element deletion thread, and make each group be executed independently. In this case, it will be of a structure to make processors and CPUs be assigned separate roles, for example.

Meanwhile, only data and programs indispensable to this exemplary embodiment are shown in FIG. 9, and general-purpose data and programs such as OS are not illustrated.

An input interface 960 interfaces an input data from various input devices. To the input interface 960, a keyboard 961, a pointing device (PD) 962 and a storage medium 963 can be connected, for example. An output interface 970 outputs processing data. A display unit 971 and a printer 972 are connected to the output interface 970, for example.

The thread control unit 101 and the data element control unit 102 of the information processing apparatus 100 shown in FIG. 1 have a hardware configuration illustrated in FIG. 9 when realized by a computer. The configuration shown in FIG. 9 has the CPUs (Central Processing Units) 910-1 to 910-n, the ROM 920, the communication control unit 930, the RAM 940, the storage 950 and the programs included in the storage 950. By executing various software programs (computer programs), the CPUs 910-1 to 910-n control overall operations of the information processing apparatus 100. In this exemplary embodiment and other exemplary embodiments indicated below, the CPUs 910-1 to 910-n execute software programs of each function (each unit) provided in the information processing apparatus 100 while referring to a storage medium such as the RAM 940 appropriately.

More specifically, by executing software programs for executing functions of the process status management unit 210 shown in FIG. 4 provided in the information processing apparatus 100 while referring to a storage medium such as the RAM 940 appropriately, the CPUs 910-1 to 910-n execute software programs such as the start-and-end processing unit 410, the end determination unit 420 and the state holding unit 430.

Processing Procedure of List Searching Thread

FIG. 10A is a flow chart showing a processing procedure of the list searching thread 202 or 203 by an information processing apparatus according to this exemplary embodiment.

First, the CPU 910-1, for example, which executes the list searching thread 202 starts the start processing unit 411. The start processing unit 411 acquires a sequence number which identifies list searching processing uniquely (Step S1011). Next, the CPU 910-1 performs a list-search (Step S1013). When the CPU 910-1 ends the list-search, the CPU 910-1 starts the end processing unit 412. As a result, the CPU 910-1 that executes the list searching thread 202 notifies the process status management unit 210 of completion of processing associated with the above-mentioned sequence number (Step S1015).

Processing Procedure of List Element Deletion Thread

FIG. 10B is a flow chart showing a processing procedure of the list element deletion thread 201 by an information processing apparatus according to this exemplary embodiment.

The CPU 910-1, for example, that executes the list element deletion thread 203 deletes a data element from list structure data, first (Step S1021). Next, the CPU 910-1 starts the maximum sequence number acquisition unit 421. The maximum sequence number acquisition unit 421 acquires the maximum sequence number from the sequence numbers associated with the pieces of search processing that have started by that point (Step S1023). Next, the maximum sequence number acquisition unit 421 notifies the minimum sequence number comparison unit 422 of the acquired maximum sequence number. The minimum sequence number comparison unit 422 examines whether the pieces of search processing associated with numbers less-than-or-equal-to the acquired sequence number have completed or not (Step S1025). As a result of the comparison, when the pieces of search processing associated with numbers less-than-or-equal-to the sequence number have not completed, the minimum sequence number comparison unit 422 repeats minimum sequence number comparison processing of Step S1025. As a result of the comparison, when the pieces of search processing associated with numbers less-than-or-equal-to the sequence number have completed, the minimum sequence number comparison unit 42 puts the deleted data element into the reusable state (Step S1027). That all pieces of search processing associated with numbers less than that sequence number have completed indicates that there exists no thread having possibility of referring to the deleted data element.

Start Processing

FIG. 11A and FIG. 11B are flow charts showing a processing procedure of start processing S1011 according to this exemplary embodiment shown in FIG. 10A. In the start processing, “state” is used as a variable that stores a copy of a “board” array element used only in this processing. Meanwhile, “/X” in the figure indicates negation of X. Also, “actual” indicates a return value from atomic “cmpxchg” operation.

The start processing unit 411 performs atomic addition of a numerical value “1” to the maximum sequence number (head), and substitutes the numerical value before the addition for variable “myseq”, first (Step S1101). The start processing unit 411 substitutes a value of an array element of the OFFSET (myseq)-th place of the “board” array for “state” (Step S1103). The start processing unit 411 examines whether a condition that the REUSE bit of variable “state” is “0, and TAG information of “state” and TAG information of “myseq” are equivalent is satisfied or not (Step S1105). When the condition in Step S1105 is satisfied, the start processing unit 411 sets “myseq” as the return value and terminates its processing (Step S1107).

On the other hand, when the condition of Step S1105 is not satisfied, the start processing unit 411 checks the REUSE bit of “state” (Step S1109). As a result, when the REUSE bit is not “0” (when a judgment of Step S1109 is “YES”), the start processing unit 411 examines whether TAG information of “state” and TAG information of “myseq” are equal or not (Step S1111). When these values are equal, the start processing unit 411 returns its processing to Step S1101. When they are different, the start processing unit 411 executes atomic “cmpxchg” operation which changes the value of the array element of the OFFSET (myseq)-th place of the “board” array to TAG (myseq) from the “state” value “” (Step S1113). Then, the start processing unit 411 examines whether the “cmpxchg” operation has succeeded or not (Step S1115). When the “cmpxchg” operation has succeeded, the start processing unit 411 executes processing following-on Step S1107. On the other hand, when the “cmpxchg” operation has failed, the start processing unit 411 substitutes a value stored in the array element of a OFFSET (myseq)-th place of the “board” array at the time of execution of the “cmpxchg” operation for “state” (Step S1123).

Then, the start processing unit 411 executes processing following-on Step S1105.

In Step S1109, when the REUSE bit is “0” (when the judgment of Step S1109 is “NO”), the start processing unit 411 checks the PASSED bit of “state” (Step S1117). As a result, when the PASSED bit is not “0” (when the judgment of Step S1117 is “NO”), the start processing unit 411 returns its processing to Step S1101. On the other hand, when the PASSED bit is “0” (when a judgment of Step S1117 is “YES”), the start processing unit 411 executes atomic “cmpxchg” operation which changes the value of the array element of the OFFSET (myseq)-th place of the “board” array into the value which is “state” value set by the PASSED flag to the “state” value (Step S1119). The start processing unit 411 examines whether the “cmpxchg” operation has succeeded or not (Step S1121). When the “cmpxchg” operation has succeeded, the start processing unit 411 returns its processing to Step S1101. On the other hand, when “cmpxchg” operation has failed, the start processing unit 411 substitutes the value stored in the array element of the OFFSET (myseq)-th place of the “board” array at the time of execution of the “cmpxchg” operation for “state” (Step S1123). Then, the start processing unit 411 executes processing following-on Step S1105.

End Processing

FIGS. 12A to 12C are flow charts showing a processing procedure of end processing S1015 according to this exemplary embodiment shown in FIG. 10A. In the end processing, as variables that store a copy of a “board” array element used only in this processing, “state” and “newv” are used. Meanwhile, “/X” in the figure represents negation of “X”. Also, “actual” indicates a return value from atomic “cmpxchg” operation.

First, the end processing unit 412 substitutes the array element of the OFFSET (myseq)-th place of the “board” array for “state” (Step S1201). Next, the end processing unit 412 checks the PASSED bit of “state” (Step S1203). When the PASSED bit is “0” (when the judgment of Step S1203 is “YES”) as a result, the end processing unit 412 sets the value made by adding “1” to “state” to “newv” (Step S1205). When the PASSED bit is not “0” (when the judgment of Step S1203 is “NO”), the end processing unit 412 sets a numerical value made by setting the REUSE bit to “state” to “newv” (Step S1207). In both cases of the judgment of Step S1203, the end processing unit 412 executes atomic “cmpxchg” operation which changes the value of the array element of the OFFSET (myseq)-th place in the “board” array to “newv” from the “state” value (Step S1209). Then, the end processing unit 412 examines whether the “cmpxchg” operation has succeeded or not (Step S1211).

When the “cmpxchg” operation has failed, the end processing unit 412 substitutes the value stored in the array element of the OFFSET (myseq)-th place of the “board” array at the time of execution of the “cmpxchg” operation for “state” (Step S1213). The end processing unit 412 executes processing following-on Step S1203. On the other hand, when the “cmpxchg” operation has succeeded, the end processing unit 412 examines whether values of “myseq” and “tail” are equal (Step S1215). When the both values are different, the end processing unit 412 finishes the operating. When both values are equal, the end processing unit 412 executes atomic “cmpxchg” operation which adds “1” to “tail”, (Step S1217), and examines whether the “cmpxchg” operation has succeeded or not (Step S1219). When the “cmpxchg” operation has failed, the end processing unit 412 finishes the processing.

On the other hand, when the “cmpxchg” operation of Step S1219 has succeeded, the end processing unit 412 adds “1” to “myseq” value (Step S1221), and substitutes the value stored in the array element of the OFFSET (myseq)-th place of the “board” array for “state” (Step S1223). Next, the end processing unit 412 examines whether the condition that the REUSE bit of the variable “state” is “0”, and TAG information of “state” and TAG information of “myseq” are equal or not (Step S1225) is satisfied or not. As a result, when the condition of Step S1225 is satisfied, the end processing unit 412 finishes the processing. When the condition of Step S1225 is not satisfied, the end processing unit 412 examines whether the condition that the REUSE bit of variable “state” is not “0” and, at the same time, TAG information of “state” and TAG information of “myseq” are different is satisfied or not (Step S1227). When the condition of Step S1227 is not satisfied as a result, the end processing unit 412 executes processing following-on Step S1215.

On the other hand, when the condition of Step S1227 is satisfied, the end processing unit 412 executes atomic “cmpxchg” operation which changes the value of the array element of the OFFSET (myseq)-th place of the “board” array to the value which is the value set by the REUSE bit and PASSED bit to the TAG value of “myseq” from the “state” value (Step S1229). Then, the end processing unit 412 examines whether the “cmpxchg” operation has succeeded or not (Step S1231). When the “cmpxchg” operation has succeeded, the end processing unit 412 returns the processing to Step S1215. On the other hand, when the “cmpxchg” operation has failed, the end processing unit 412 compares the TAG value of the value stored in the array element of the OFFSET (myseq)-th place of the “board” array at the time of execution of the “cmpxchg” operation and the TAG information of “myseq” (Step S1233). When these values are different as a result, the end processing unit 412 returns the processing to Step S1215. When these values are equal, the end processing unit 412 finishes its processing.

Maximum Sequence Number Acquisition Processing

FIG. 13 is a flow chart showing a processing procedure of maximum sequence number acquisition processing S1023 according to this exemplary embodiment shown in FIG. 10B.

When the maximum sequence number acquisition unit 421 starts, it acquires the “head” value at the time of the start. Then, the maximum sequence number acquisition unit 421 sets the acquired “head” value as the return value and terminates its processing (Step S1301).

Minimum Sequence Number Comparison Processing

FIG. 14 is a flow chart showing a processing procedure of minimum sequence number comparison processing S1025 according to this exemplary embodiment shown in FIG. 10B.

First, the minimum sequence number comparison unit 422 compares the “myseq” value which has been handed as an argument and the “tail” value at the time of the start (Step S1401). When, as a result, the “tail” value and the “myseq” value are equal or the “tail” value is larger, the minimum sequence number comparison unit 422 finishes processing, setting the return value to “true” (Step S1403). On the other hand, when the “tail” value is less than the “myseq” value, the minimum sequence number comparison unit 422 finishes its processing, setting the return value to “false” (Step S1405).

Meanwhile, as an existing technology related to expressing a sequence number as an integer which can be handled by a computer, there exists a large and small comparison method which takes an overflow of a numerical value related to a physical expression into consideration. As an example, in a “source code” of “Linux kernel”, there is a macro definition that is “#defineUINT_CMP_LT (a, b) (UINT_MAX/2<(a)−(b))” (UINT_MAX is the maximum value of numerical values that can be expressed by a UINT type). By adopting such large and small comparison method for two integers which takes an overflow into consideration as comparison operation of sequence numbers in this exemplary embodiment, an overflow of a sequence number is permitted. That is, processing state management using a sequence number which can be understood to be increasing uniquely as a matter of logic, although a sequence number value decreases at the time of occurrence of an overflow in a physical expression, is also included in the present invention.

### Third Exemplary Embodiment

Next, an information processing system according to the third exemplary embodiment of the present invention will be described.

Structure of Information Processing System

FIG. 15 is a block diagram showing a structure of an information processing system 1500 according to this exemplary embodiment.

As shown in FIG. 15, a processor A 1510 and a processor B 1520 execute processing, sharing the same memory unit 1530. In FIG. 15, the processor A 1510 is executing a list element deletion thread 1511. At the same time, the processor B 1520 is executing a list searching thread 1521 in a parallel way.

When compared with the second exemplary embodiment mentioned above, the information processing system according to this exemplary embodiment is different in a point that each processor shares a state holding unit, while each performs processing state management. Because other structures and operations are the same as those of the second exemplary embodiment, the detailed description will be omitted.

In such processing environment, that one process status management unit manages a plurality of threads which a plurality of processors process and processes inquiries from each thread increases an overhead. Accordingly, in the information processing system 1500 shown in FIG. 15, the processors include a process status management units 1512 and 1522, respectively, having the start-and-end processing unit 410 and the end determination unit 420 (excluding a state holding unit). Because a state holding unit 1532 is used in a way shared by processors and threads, it is stored in a memory unit 1530 along with list-structured data 1531.

According to this exemplary embodiment, by decentralized management by each processor, the deleted data element can be put into the reusable state quickly without affecting the running threads by the deletion of the data element from the list-structured data. Meanwhile, it may be constituted such that each processor has a state holding unit, and these state holding units always have identical information.

### Other Embodiments

Although the exemplary embodiments of the present invention have been explained in detail above, a system or an apparatus formed by combining separate features included in the respective exemplary embodiments in any manner is also included within the category of the present invention.

The present invention can be applied to the other usage in the information processing system in which a plurality of threads can insert or delete a plurality of data elements into or from structural data such as a list dynamically in a parallel way, the information processing system being able to determine whether the deleted data element is reusable or non-reusable quickly and efficiently.

The present invention may be applied to a system including a plurality of apparatus or may be applied to a stand-alone apparatus. Further, the present invention is applicable in a case where a control program which realizes the functions of the exemplary embodiments is supplied to a system or an apparatus directly or remotely. Accordingly, a control program installed in a computer in order to realize the functions of the present invention by the computer, a medium storing the control program or a WWW (World Wide Web) server which makes the control program be downloaded is also included in the category of the present invention.

Meanwhile, the present invention that has been described taking the exemplary embodiments mentioned above as an example has been described about a case where an information processing apparatus mentioned above is realized by a software program as an example which the CPUs 910-1 to 910-n shown in FIG. 9 execute. However, a part or all of the functions shown in each block shown in FIG. 1, FIG. 2, FIG. 4 and FIG. 15 may be realized as hardware.

Also, the present invention that has been described taking the exemplary embodiments mentioned above as an example is achieved by, after supplying to the information processing apparatus 900 mentioned above a computer program which can realize the functions of the flow charts (FIGS. 10A to 14) referred to in the description of the information processing apparatus 900, reading out the computer program into the CPUs 910-1 to 910-n of the information processing apparatus 900 and then executing it.

Further, such supplied computer program should be simply stored in a computer-readable storage device such as a memory (temporary storage medium) or a hard disk device which can be read and written. In such case, the present invention can be thought that it is formed by a cord representing the computer program or a storage medium storing the computer program.

### INDUSTRIAL APPLICABILITY

For example, the present invention can be applied to an information processing apparatus which executes a plurality of threads in parallel.

Other Expressions of Exemplary Embodiments

A part or all of the above-mentioned exemplary embodiments can also be described as, but not limited to, the following supplementary notes.

(Supplementary Note 1)

An information processing apparatus, including:

thread control means for, at starting a plurality of threads, giving an identifier to the thread, and, at ending the each thread, notifying of an end along with the identifier; and

data element control means for, in case that a deletion thread which deletes a data element from list-structured data being executed, maintaining a content of the deleted data element in an unmodifiable state until ends of all the threads which started before the deletion processing by the deletion thread being confirmed by a notification of the end along with the identifier, and, in case that the ends of all the threads which started before the deletion processing by the deletion thread being notified of along with the identifier, putting the deleted data element into a reusable state.

(Supplementary Note 2)

The information processing apparatus according to Supplementary note 1, wherein

the thread control means acquires the identifier of a latest thread at a completion time of the deletion processing by the deletion thread, and

the data element control means examines, in response to an inquiry of whether the latest thread and all the threads which started running before the latest thread ended or not, whether the ends of the latest thread and all the threads which started running before the latest thread is notified of along with the identifier or not, and, in case the ends being notified of, puts the deleted data element into the reusable state.

(Supplementary Note 3)

The information processing apparatus according to Supplementary notes 1 or 2, wherein,

the thread control means gives the identifier, at starting a search thread which accesses the list-structured data, except for the deletion thread, and notifies of the end along with the identifier at ending the search thread.

(Supplementary Note 4)

The information processing system according to supplementary note 3, wherein the thread control means gives, at starting search processing by the search thread, the identifier to the search thread, and, at ending the search thread, receives the identifier from the search thread.

(Supplementary Note 5)

The information processing apparatus according to any one of Supplementary notes 1 to 3, wherein

the thread control means further includes: state holding means for calculating an address based on a starting sequence included in the identifier, and holding a state of a running thread in a position of the address; and

controls information, stored in the state holding means, which indicates the end of the thread corresponding to the identifier, and

the data element control means determines whether the deleted data element is reusable or not based on the information, stored in the state holding means, which indicates the end of the thread corresponding to the identifier.

(Supplementary Note 6)

The information processing apparatus according to Supplementary note 4, wherein

the state holding means includes an prescribed address area, and holds an array element indicating a state of the each thread in a manner circulating the address area in the starting sequence of the thread, and
the each array element includes:
a flag which indicates the passing was performed, in a second round or later, to the array element corresponding to the thread of which the end is not notified of, and
a flag which indicates the end of the thread corresponding to the array element to which the passing was performed is notified of.

(Supplementary Note 7)

The information processing apparatus according to any one of Supplementary notes 1 to 5, wherein

the thread control means includes:

state holding means for holding a maximum sequence number being the identifier given to the thread which is started lastly, a minimum sequence number being a sequence number of the thread before which all the threads ended; and sequence number management data including information indicating the start and the end of the each thread; and

start-and-end processing means for including a start processing unit which gives the sequence number increased uniquely to the thread which is started, and an end processing unit which reflects completion of the thread corresponding to the sequence number in the sequence number management data, and wherein

the thread control means calls the start processing unit at starting the search processing by the search thread which accesses the list-structured data, and calls the end processing unit at ending the search processing by the search thread, and

the data element control means
includes end determination means for including: a maximum sequence number acquisition unit which acquires the maximum sequence number from the state holding means in response to a request from the deletion thread and returns the maximum sequence number; and a minimum sequence number comparison unit which compares the maximum sequence number acquired from the deletion thread and the minimum sequence number held by the state holding means, and wherein

determines whether the data element deleted by the deletion thread is reusable or not, by calling the maximum sequence number acquisition unit and the minimum sequence number comparison unit after the deletion processing of the data element by the deletion thread.

(Supplementary Note 8)

An information processing system, including:

processing means for executing a search thread which searches for list-structured data and a deletion thread which deletes a data element from list-structured data; and

processing state management means for managing execution of a plurality of threads by the processing means, wherein

the processing state management means includes:

state holding means for holding a maximum sequence number being an identifier given to the thread which is started lastly, a minimum sequence number being a sequence number of the thread before which all the threads ended, and sequence number management data including information indicating a start and an end of the each thread,

start-and-end processing means for including a start processing unit which gives the sequence number uniquely increased to the thread which is started, and an end processing unit which reflects completion of the thread corresponding to the sequence number in the sequence number management data, and

end determination means for including a maximum sequence number acquisition unit which acquires the maximum sequence number from the state holding means in response to a request from the deletion thread and returns the maximum sequence number, and a minimum sequence number comparison unit which compares the maximum sequence number acquired from the deletion thread and the minimum sequence number held by the state holding means, wherein

calls the start processing unit at starting search processing by the search thread, and calls the end processing unit at ending search processing by the search thread, and by calling the maximum sequence number acquisition unit and the minimum sequence number comparison unit after deletion processing of the data element by the deletion thread, determines whether the data element deleted by the deletion thread is reusable or not.

(Supplementary Note 9)

An information processing method, including:

giving, at starting a plurality of threads, an identifier to each thread;

notifying, at ending of the each thread, of the end along with the identifier;

in case that a deletion thread which deletes a data element from list-structured data being executed, maintaining a content of the deleted data element in an unmodifiable state until the ends of all the threads which started before a deletion processing by the deletion thread being confirmed by a notification of the end along with the identifier; and

in case that the ends of all the threads which started before the deletion processing by the deletion thread being notified of along with the identifier, putting the deleted data element into a reusable state.

(Supplementary Note 10)

The information processing method according to Supplementary note 8, further including:

holding a maximum sequence number being the identifier given to the thread which is started lastly, a minimum sequence number being a sequence number of the thread before which all the threads ended, and sequence number management data including information indicating the start and the end of the each thread in state holding means;

giving a sequence number uniquely increased to the started thread;

reflecting completion of the thread corresponding to the sequence number to the sequence number management data when the end is notified of from the thread;

in response to a request from a deletion thread which deletes a data element from list-structured data, acquiring the maximum sequence number from the state holding means and returning the maximum sequence number; and,

in case, as a result of comparing the maximum sequence number acquired from the deletion thread and the minimum sequence number, the maximum sequence number and the minimum sequence number being equal or the maximum sequence number being larger than the minimum sequence number, putting the data element deleted by the deletion thread into a reusable state.

(Supplementary Note 11)

A control program storage medium storing a control program for causing a computer to perform:

a processing that, at starting a plurality of threads, gives an identifier to each thread;

a processing that, at ending the each thread, notifies of the end along with the identifier;

a processing that, in case a deletion thread which deletes a data element from list-structured data being executed, maintaining a content of the deleted data element in an unmodifiable state until ends of all the threads which started before deletion processing by the deletion thread being confirmed by a notification of the end along with the identifier; and

a processing that, in case the ends of all the threads started before the deletion processing by the deletion thread is notified of along with the identifier, putting the deleted data element into a reusable state.

Although the present invention has been described with reference to the exemplary embodiments above, the present invention is not limited to the above-mentioned exemplary embodiments. Various modifications which a person skilled in the art can understand can be performed in the composition and details of the present invention within the scope of the present invention.

This application claims priority based on Japanese application Japanese Patent Application No. 2011-167691, filed on Jul. 29, 2011, the disclosure of which is incorporated herein in its entirety.

### REFERENCE SIGNS LIST

100 information processing system
101 thread control unit
102 data element control unit
210 process status management unit
220 memory unit
410 process status management unit
420 end determination unit
430 state holding unit
411 start processing unit
412 end processing unit
421 maximum sequence number acquisition unit
422 minimum sequence number comparison unit
431 maximum sequence number
432 minimum sequence number
433 sequence number management data

1. An information processing apparatus, comprising:
a thread control unit that, at starting a plurality of threads, gives an identifier to the thread, and, at ending the each thread, notifies of an end along with the identifier; and
a data element control unit that, in case that a deletion thread which deletes a data element from list-structured data being executed, maintains a content of the deleted data element in an unmodifiable state until ends of all the threads which started before the deletion processing by the deletion thread being confirmed by a notification of the end along with the identifier, and, in case that the ends of all the threads which started before the deletion processing by the deletion thread being notified of along with the identifier, puts the deleted data element into a reusable state.

2. The information processing apparatus according to claim 1, wherein
the thread control unit acquires the identifier of a latest thread at a completion time of the deletion processing by the deletion thread, and the data element control unit examines, in response to an inquiry of whether the latest thread and all the threads which started running before the latest thread ended or not, whether the ends of the latest thread and all the threads which started running before the latest thread is notified of along with the identifier or not, and, in case the ends being notified of, puts the deleted data element into the reusable state.

3. The information processing apparatus according to claim 1, wherein,
the thread control unit gives the identifier, at starting a search thread which accesses the list-structured data, except for the deletion thread, and notifies of the end along with the identifier at ending the search thread.

4. The information processing apparatus according to claim 1, wherein
the thread control unit further comprises: a state holding unit that calculates an address based on a starting sequence included in the identifier, and holding a state of a running thread in a position of the address; and
controls information, stored in the state holding unit, which indicates the end of the thread corresponding to the identifier, and
the data element control unit determines whether the deleted data element is reusable or not based on the information, stored in the state holding unit, which indicates the end of the thread corresponding to the identifier.

5. The information processing apparatus according to claim 4, wherein the state holding unit includes an prescribed address area, and holds an array element indicating a state of the each thread in a manner circulating the address area in the starting sequence of the thread, and
the each array element includes:
a flag which indicates the passing was performed, in a second round or later, to the array element corresponding to the thread of which the end is not notified of, and
a flag which indicates the end of the thread corresponding to the array element to which the passing was performed is notified of

6. The information processing apparatus according to claim 1, wherein
the thread control unit includes:
a state holding unit that holds a maximum sequence number being the identifier given to the thread which is started lastly, a minimum sequence number being a sequence number of the thread before which all the threads ended; and sequence number management data including information indicating the start and the end of the each thread; and
a start-and-end processing unit that includes a start processing unit which gives the sequence number increased uniquely to the thread which is started, and an end processing unit which reflects completion of the thread corresponding to the sequence number in the sequence number management data, and wherein
the thread control means calls the start processing unit at starting the search processing by the search thread which accesses the list-structured data, and calls the end processing unit at ending the search processing by the search thread, and
the data element control unit includes an end determination unit that includes: a maximum sequence number acquisition unit which acquires the maximum sequence number from the state holding unit in response to a request from the deletion thread and returns the maximum sequence number; and a minimum sequence number comparison unit which compares the maximum sequence number acquired from the deletion thread and the minimum sequence number held by the state holding unit, and wherein
determines whether the data element deleted by the deletion thread is reusable or not, by calling the maximum sequence number acquisition unit and the minimum sequence number comparison unit after the deletion processing of the data element by the deletion thread.

7. An information processing system, comprising:
a processing unit that executes a search thread which searches for list-structured data and a deletion thread which deletes a data element from list-structured data; and
a processing state management unit that manages execution of a plurality of threads by the processing unit, wherein
the processing state management unit includes:
a state holding unit that holds a maximum sequence number being an identifier given to the thread which is started lastly, a minimum sequence number being a sequence number of the thread before which all the threads ended, and sequence number management data including information indicating a start and an end of the each thread,
a start-and-end processing unit that includes a start processing unit which gives the sequence number uniquely increased to the thread which is started, and an end processing unit which reflects completion of the thread corresponding to the sequence number in the sequence number management data, and
an end determination unit that includes a maximum sequence number acquisition unit which acquires the maximum sequence number from the state holding unit in response to a request from the deletion thread and returns the maximum sequence number, and a minimum sequence number comparison unit which compares the maximum sequence number acquired from the deletion thread and the minimum sequence number held by the state holding unit, wherein
calls the start processing unit at starting search processing by the search thread, and calls the end processing unit at ending search processing by the search thread, and by calling the maximum sequence number acquisition unit and the minimum sequence number comparison unit after deletion processing of the data element by the deletion thread, determines whether the data element deleted by the deletion thread is reusable or not.

8. An information processing method, comprising:
giving, at starting a plurality of threads, an identifier to each thread;
notifying, at ending of the each thread, of the end along with the identifier;
in case that a deletion thread which deletes a data element from list-structured data being executed, maintaining a content of the deleted data element in an unmodifiable state until the ends of all threads which started before a deletion processing by the deletion thread being confirmed by a notification of the end along with the identifier; and
in case that the ends of all the threads which started before the deletion processing by the deletion thread being notified of along with the identifier, putting the deleted data element into a reusable state.

9. The information processing method according to claim 8, further comprising:
holding a maximum sequence number being the identifier given to the thread which is started lastly, a minimum sequence number being a sequence number of the thread before which all the threads ended, and sequence number management data including information indicating the start and the end of the each thread in a state holding unit;
giving a sequence number uniquely increased to the started thread;
reflecting completion of the thread corresponding to the sequence number to the sequence number management data when the end is notified of from the thread;
in response to a request from a deletion thread which deletes a data element from list-structured data, acquiring the maximum sequence number from the state holding unit and returning the maximum sequence number; and,
in case, as a result of comparing the maximum sequence number acquired from the deletion thread and the minimum sequence number, the maximum sequence number and the minimum sequence number being equal or the maximum sequence number being larger than the minimum sequence number, putting the data element deleted by the deletion thread into a reusable state.

10. A non-transitory computer-readable storage medium storing a control program causing a computer to perform:
a processing that, at starting a plurality of threads, gives an identifier to each thread;
a processing that, at ending the each thread, notifies of the end along with the identifier;
a processing that, in case a deletion thread which deletes a data element from list-structured data being executed, maintaining a content of the deleted data element in an unmodifiable state until ends of all threads which started before deletion processing by the deletion thread being confirmed by a notification of the end along with the identifier; and
a processing that, in case the ends of all the threads started before the deletion processing by the deletion thread is notified of along with the identifier, putting the deleted data element into a reusable state.
